(19) United States
(12) Patent Application Publication
(10) Pub. No.: US 2012/0091822 A1
(43) Pub. Date: Apr. 19, 2012

(54) Method For A Power Distribution System Comprising Two Selectively Tripping Switches

(75) Inventors: Ludwig Birkl, Kelheim (DE); Josef Götz, Freudenberg-Aschach (DE)

(73) Assignee: SIEMENS AKTIENGESELLSCHAFT, Munich (DE)

(21) Appl. No.: 13/274,377

(22) Filed: Oct. 17, 2011

(30) Foreign Application Priority Data
Oct. 18, 2010 (DE) 10 2010 042 569.9

(51) Int. Cl. H02B 99/00

(52) U.S. Cl. 307/115

(57) ABSTRACT

In at least one embodiment, a method includes setting a dedicated current limit value for the upstream switch; opening the upstream switch each time a current limit value thereof exceeds the set dedicated current limit for a set time; connecting the two switches to one another in terms of signaling; and signaling the upstream switch, via the downstream switch, each time the downstream switch is going to interrupt the current, at least one of the current limit value being increased and the set time of the upstream switch being extended each time the downstream switch signals that it is going to interrupt the current.

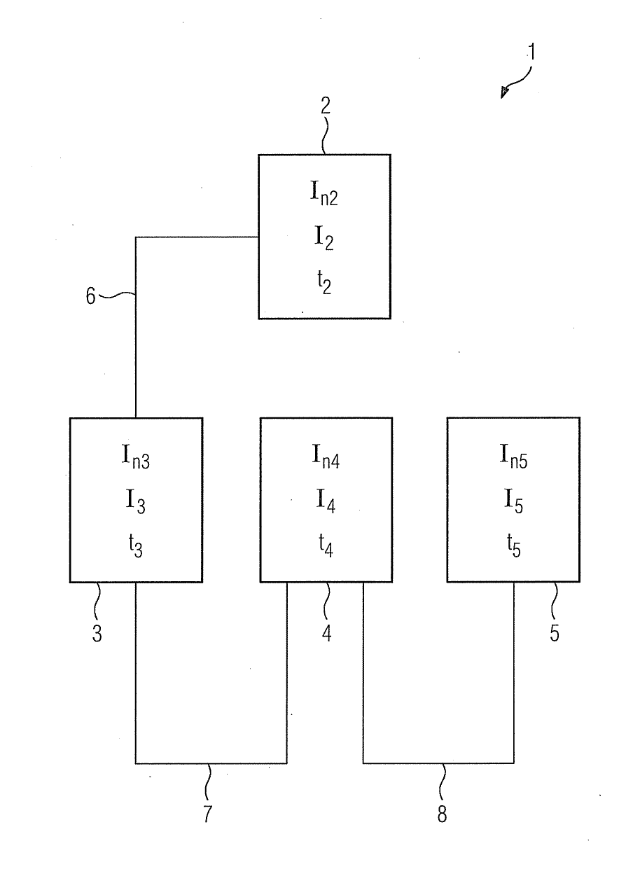

### PRIORITY STATEMENT

The present application hereby claims priority under 35 U.S.C. §119 on German patent application number DE 10 2010 042 569.9 filed Oct. 18, 2010, the entire contents of which are hereby incorporated herein by reference.

### FIELD

At least one embodiment of the invention generally relates to a method for a power distribution system including two selectively tripping switches.

### BACKGROUND

Circuit breakers for low voltages are known as switches which are used in power distribution installations. They are designed in each case for a rated current and interrupt the current (alternating current) flowing through the switch when said current exceeds a predetermined current limit value, which is the case in particular in the event of a short circuit. In order to detect the current, in each case one current transformer is arranged at the electrical conductor which runs through the switch. An electronic tripping unit compares the detected current with the current limit value and opens the switch automatically by virtue of it isolating the contacts when the current limit value is exceeded.

In the case of power distribution, the current via a downstream switch also flows via the upstream switch. In this case, a plurality of switches of different sizes and with different switch rated currents are generally installed in a power distribution installation, with the size and the switch rated current decreasing from the infeed to the consumer; this is also referred to as staggering in the rated current ratio.

In the event of a short circuit, the switches have a selective response with respect to one another, wherein selectivity means that in each case only that switch which is closest to the short circuit trips.

In the case of time selectivity, each (upstream) switch has a delay time which is longer the higher the rated current is and the greater the maximum number of switches that can be or are arranged downstream thereof. Thus, in the case of selective staggering in the rated current ratio of 1:1.6, the delay times in the switch with the greatest rated current are selected to be markedly greater than in the case of staggering in the rated current ratio of 1:2.5.

If the tripping unit of the upstream switch, for example, identifies a short circuit (that its predetermined current limit value has been exceeded), it first waits for the delay time (i.e. 25 ms, for example). In this time, it gives the downstream switch the option of disconnecting the short circuit. The tripping unit in the upstream switch only trips when the short circuit has not been disconnected by a downstream switch once the delay time has elapsed.

In the case of zone selectivity, the switches are connected to one another by way of connecting lines in the form of a twisted twin-wire line, wherein the connecting lines together with a current source form a closed circuit. If a predetermined current limit value is exceeded, the downstream switch in each case emits a signal (blocking signal) onto the connecting lines. In the simplest case, the signal is a current level. In this way, the downstream switch signals to the upstream switch that its predetermined current limit value has been exceeded and it is going to interrupt the current.

By virtue of the signal, the upstream switch is only opened after the predetermined delay time, i.e. as long as it is virtually blocked, which can result in destruction of the switch.

### SUMMARY

In at least one embodiment of the invention, all of the switches in a power distribution system are protected in which the switches are connected selectively to one another in the sense of zone selectivity.

At least one embodiment provides that the current limit value is in each case increased and/or the time of the upstream switch is in each case extended whenever the downstream switch signals that it is going to interrupt the current. The concept of the solution therefore resides in that the upstream switch does not use the signal of the downstream switch as a blocking signal, but alters its current limit value and/or its delay time, i.e. generally increases both. As a result, tripping of the upstream switch is prevented in the selective case; nevertheless, the inherent protection of the upstream switch is maintained. The current limit value and/or the delay time are selected such that they are above the possible forward values of the switch arrangement (switch combination) comprising at least one upstream and at least one downstream switch, but are below the values which can occur on their own in a switch. In general terms, in the event of the occurrence of the signal, a change in the protective parameter, i.e. in particular the current limit values and/or the delay times, of the entire switch arrangement formed from at least two switches is performed. The change in the protective parameter is performed in such a way that both the selectivity and the self-protection of the switches are ensured.

### BRIEF DESCRIPTION OF THE DRAWINGS

At least one embodiment of the invention will be described in more detail below with reference to the drawing, in which a single figure shows schematically a power distribution system 1 with circuit breakers for low voltages, an upstream switch 2 and three downstream parallel-connected switches 3, 4, 5.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The switches 2, 3, 4, 5 are designed for a rated current In2, In3, In4, In5, respectively, and interrupt the current I (alternating current) flowing through the switch 2, 3, 4, 5 when the current exceeds a predetermined current limit value I2, I3, I4, I5 (current limit value I2 in the case of switch 2, in the case of switch 3, . . . ), which is the case in particular in the event of a short circuit. In order to detect the current I, in each case one current transformer is arranged at the electrical conductor which runs through the switch 2, 3, 4, 5.

The current I via the parallel-connected downstream switches 3, 4, 5 also flows via the upstream switch 2.

The upstream switch 2 has a current limit value of I2=10×In (10 times the rated current In) and a delay time of t2=3 ms.

In the event of a short circuit, the switches 2, 3, 4, 5 have a selective response with respect to one another, i.e. in each case only that switch 2, 3, 4, 5 which is closest to the short circuit trips.

Furthermore, the switches 2, 3, 4, 5 are each connected to one another in pairs by means of connecting lines 6, 7, 8 in the form of twisted twin-wire lines, wherein the connecting lines 6, 7, 8 together with a current source form a closed circuit. Thus, the connecting line 6 connects the two switches 2 and 3, the connecting line 7 connects switches 3 and 4, and the connecting line 8 connects the switches 4 and 5.

If the predetermined current limit value I3 of the switch 3 is exceeded, for example in the event of a short circuit, said switch emits a current level as a signal onto the connecting line 6. In this way, the (downstream) switch 3 signals to the (upstream) switch 2 that its predetermined current limit value 13 has been exceeded and it is going to interrupt the current I.

On reception of the signal, the tripping unit of the switch 2 sets its current limit value Ii to 30×In and the delay time t to 8 ms. If the current through the switch 2 rises above a value of 30×In prior to the time of 8 ms elapsing owing to the short circuit, the switch 2 trips and interrupts the current I.

Without a signal, the switch 2 is adjusted with respect to its current limit value I2 and its predetermined delay time t2 such that it trips as quickly as possible. This is slightly impaired in the case of Ii=30×In and t=8 ms. For this, the switch 2 is correspondingly protected in the event of a short circuit.

The switch arrangement of the power distribution system 1 therefore has, by way of summary, in relation to the switches 2, 3, a switch 2 which is upstream when viewed from the infeed and a switch 3 which is downstream of said upstream switch. The current I flowing through the switch 3 in this case also flows via the switch 2 in the event of a short circuit. A dedicated current limit value 12 is predetermined for the switch 2; the switch opens in each case whenever the current limit value I2 is exceeded for a predetermined time. The two switches 2, 3, are connected to one another in terms of signaling. In the event that the current limit value I3 of the switch 3 is exceeded, the switch 3 signals to the switch 2 in each case that it is going to interrupt the current I. Thereupon, the switch 2 increases its current limit value I2 and/or extends the time t2.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for a power distribution system including two switches, with one of the two switches being arranged relatively upstream and the other of the two switches being arranged relatively downstream when viewed from an infeed, the method comprising:
establishing that a current flowing via the downstream switch will also flow via the upstream switch;
setting a dedicated current limit value for the upstream switch;
opening the upstream switch each time a current limit value thereof exceeds the set dedicated current limit for a set time;
connecting the two switches to one another in terms of signaling; and
signaling the upstream switch, via the downstream switch, each time the downstream switch is going to interrupt the current, at least one of the current limit value being increased and the set time of the upstream switch being extended each time the downstream switch signals that it is going to interrupt the current.

2. The method as claimed in claim 1, wherein the signaling takes place by way of a signal which is emitted, by the downstream switch, on connecting lines, which connect the upstream switch and the downstream switch to one another.

3. A method for a power distribution system including two switches, one of the two switches being arranged relatively upstream and the other of the two switches being arranged relatively downstream when viewed from an infeed, the method comprising:
setting a dedicated current limit value for the upstream switch;
opening the upstream switch each time a current limit value thereof exceeds the set dedicated current limit for a set time;
connecting the two switches to one another in terms of signaling; and
signaling the upstream switch, via the downstream switch, each time the downstream switch is going to interrupt the current, at least one of the current limit value being increased and the set time of the upstream switch being extended each time the downstream switch signals that it is going to interrupt the current.

4. The method as claimed in claim 3, wherein the signaling takes place by way of a signal which is emitted, by the downstream switch, on connecting lines, which connect the upstream switch and the downstream switch to one another.

5. A method for a power distribution system including two switches, one of the two switches being arranged relatively upstream and the other of the two switches being arranged relatively downstream when viewed from an infeed, the upstream switch including a dedicated current limit value such that the upstream switch will be opened each time a current limit value thereof exceeds the set dedicated current limit for a set time, the method comprising:
signaling the upstream switch, via the downstream switch, each time the downstream switch is going to interrupt the current; and
each time the downstream switch signals that it is going to interrupt the current, at least one of
increasing the current limit value, and
extending the set time of the upstream switch.

6. The method as claimed in claim 5, wherein the signaling takes place by way of a signal which is emitted, by the downstream switch, on connecting lines, which connect the upstream switch and the downstream switch to one another.
